(19) United States
(12) Patent Application Publication
(10) Pub. No.: US 2014/0250028 A1
(43) Pub. Date: Sep. 4, 2014

(54) SYSTEMS AND METHODS FOR PROVIDING A USER WITH REAL TIME INTERNATIONAL SHIPPING RATES FROM A PLURALITY OF FREIGHT FORWARDERS

(71) Applicant: CATAPULT INTERNATIONAL, LLC, Lenexa, KS (US)

(72) Inventor: Matthew Philip Motsick, Shawnee, KS (US)

(73) Assignee: Catapult International, LLC, Lenexa, KS (US)

(21) Appl. No.: 13/782,885

(22) Filed: Mar. 1, 2013

(51) Int. Cl. G06Q 10/08

(52) U.S. Cl. CPC G06Q 10/08345
USPC 705/335

(57) ABSTRACT

A system for providing a user with international shipping rates in real time. The system includes a client, a shipping rates database comprising current shipping rate information for a plurality of freight forwarders, and a server comprising a processor. The processor is programmed to receive, from the client, a request for shipping rates for shipping a freight from an origin location in an origin country to a destination location in a destination country, access, from the shipping rates database, current shipping rate information for each of the plurality of freight forwarders, and send the client a shipping rate for each of the plurality of freight forwarders based on shipping the freight from the origin location to the destination location.

### BACKGROUND OF THE INVENTION

The subject matter described herein relates generally to international shipping rates and, more particularly, to systems and methods for providing a user with real time international shipping rates from a plurality of different freight forwarders.

Freight forwarding is a service used by businesses that deal in international or multi-national import and export. A freight forwarder or a non-vessel operating common carrier (NVOCC) is a person or company that organizes shipments for businesses to send goods from an origin (e.g., a manufacturer or producer) to a destination (e.g., a market, a customer, or final point of distribution) by contracting with carriers that will handle the freight as well as processing any necessary paperwork. Thus, a freight forwarder acts as an intermediary between the client and one or more carrier types, including ships, airplanes, trucks, and railroads, as it is not unusual for a single shipment to move on multiple modes.

While a freight forwarder handles the considerable logistics involved in international shipments for a client, relieving what would otherwise be a formidable burden, another advantage of using a freight forwarder is that a freight forwarder also handles ancillary services that are a part of the international shipping business. Insurance and customs documentation and clearance are some examples. As a consolidator, a freight forwarding service might also provide documentation or bills of lading processing.

Further, there are more than 300 different ocean surcharges on a worldwide scale. An ocean shipping rate could consist of potentially more than 12 different surcharges that are fluctuating all the time. Air rates change on a daily basis. As such, before providing a client with a quote for international shipping, a freight forwarder must obtain up-to-date surcharges/carrier charges. Thus, due to the complexity of the process and the numerous surcharges/fees associated therewith, providing a client with a quote for international shipping can easily take 24-48 hours.

As such, there is a need for an improved method that enables a client/shipper to instantly obtain international shipping rates from one or more freight forwarders.

### BRIEF DESCRIPTION OF THE INVENTION

In one aspect, a system for providing a user with international shipping rates in real time is provided. The system includes a client, a shipping rates database comprising current shipping rate information for a plurality of freight forwarders, and a server comprising of a processor. The processor is programmed to receive, from the client, a request for shipping rates for shipping freight from an origin location in an origin country to a destination location in a destination country, access, from the shipping rates database, current shipping rate information for each of the plurality of freight forwarders, and send the client a shipping rate for each of the plurality of freight forwarders based on shipping the freight from the origin location to the destination location

In another aspect, a method for providing a user with international shipping rates in real time is provided. The method includes receiving a request for shipping rates for shipping a freight from an origin location in an origin country to a destination location in a destination country, accessing, from a shipping rates database comprising current shipping rate information for a plurality of freight forwarders, current shipping rate information for each of the plurality of freight forwarders, and displaying, on a display device, a shipping rate for each of the plurality of freight forwarders based on shipping the freight from the origin location to the destination location.

In yet another aspect, at least one computer-readable storage medium having computer-executable instructions embodied thereon. When executed by at least one processor, the computer-executable instructions cause the at least one processor to receive a request for shipping rates for shipping a freight from an origin location in an origin country to a destination location in a destination country, access, from a shipping rates database comprising current shipping rate information for a plurality of freight forwarders, current shipping rate information for each of the plurality of freight forwarders, and display, on a display device, a shipping rate for each of the plurality of freight forwarders based on shipping the freight from the origin location to the destination location.

### BRIEF DESCRIPTION OF THE DRAWINGS

FIG. 1 is an exemplary system having a server in communication with a shipping rates database and a client.

FIG. 2 is a swimlane diagram of an exemplary method for providing a user with international shipping rates in real time.

### DETAILED DESCRIPTION OF THE INVENTION

Shipping freight internationally can be a stressful and time consuming process. Not only it takes anywhere between 24 to 48 hours to receive a quote from a traditional freight forwarder, rates also can vary dramatically based on weight, size, location and providers. Thus, finding and comparing rates from different rate providers can not only be time consuming, but extremely difficult.

The present disclosure enables importers and exporters to quote, compare and book international air and ocean rates within seconds from multiple freight forwarders. Further, while some shipping rate providers only offer limited air cargo rates, embodiments of the present disclosure enable a user to have access to global air and ocean cargo rates, including full container load (FCL) and less than full containers (LCL), all from one system.

As such, instead of waiting for hours or days to get a quote back from traditional freight forwarders, embodiments of the present disclosure enables a user to instantly have access to international shipping rates from multiple freight forwarders.

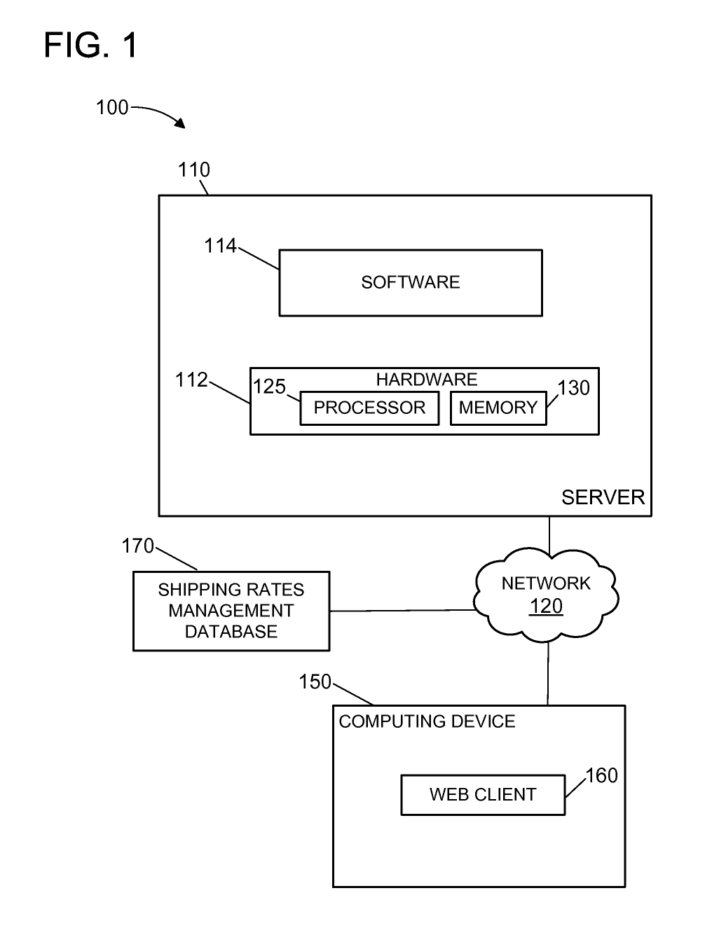

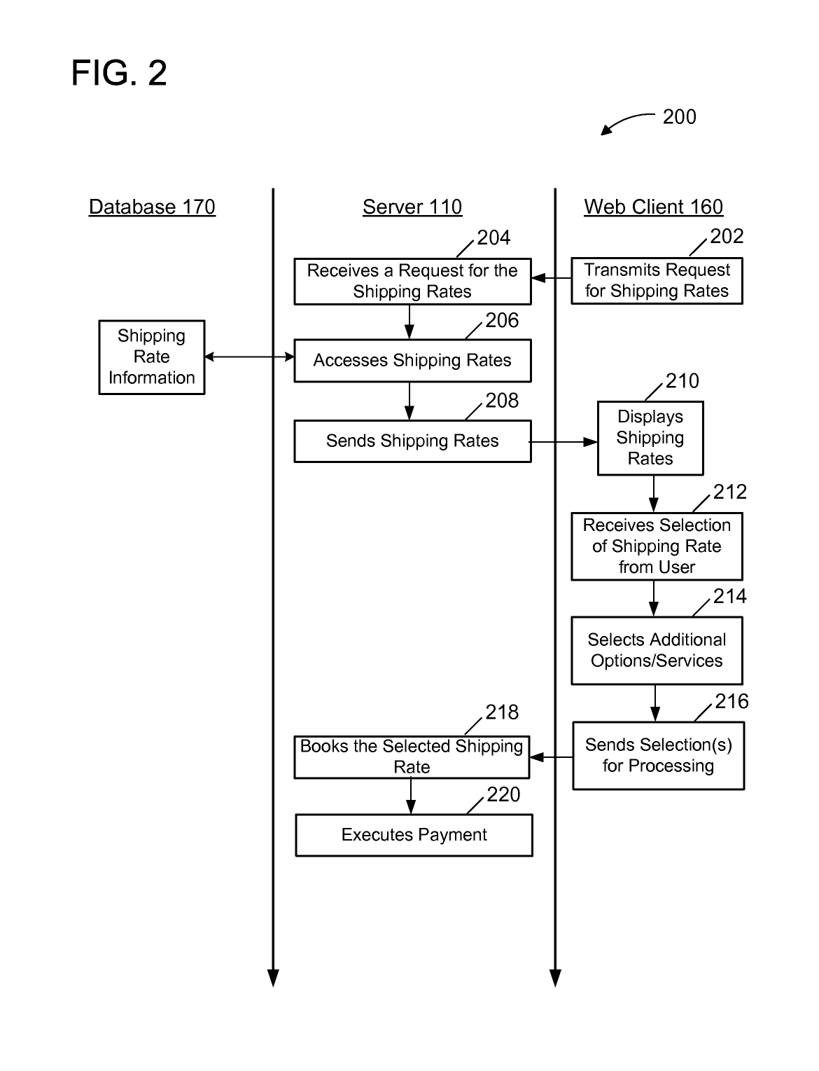

With reference now to FIG. 1, an exemplary system 100 that includes a server 110 is provided. Server 110 includes hardware 112 and software 114 running on hardware 112 such that various applications may be executing on hardware 112 by way of software 114. Software 114 may be implemented directly in hardware 112, e.g., as a system-on-a-chip, firmware, FPGA, etc. Hardware 112 includes at least one processor 125, wherein each processor is an execution unit, or “core,” on a microprocessor chip. Hardware 112 also includes a system memory 130, which is a general volatile random access memory (RAM), a network interface (NIC), and other devices. Memory 130 or other computer-readable media, stores computer-executable instructions. For example, memory 130 stores computer-executable instructions referred to herein as program code (e.g., object code and/or source code) that may be read and executed by processor 125, which causes processor 125 to perform the process described in further detail below with respect to FIG. 2.

However, while computer-executable instructions/program code are described as being stored in memory 130, program code may be stored and accessed from a memory area remote from server 110. For example, the program code may be located in a functional form on non-transitory computer-readable media that is selectively removable and may be loaded onto or transferred to server 110 for execution by processor 125. The program code and computer-readable media form computer program product in these examples. In one example, computer-readable media may be in a tangible form, such as, for example, an optical or magnetic disc that is inserted or placed into a drive or other device that is part of persistent storage for transfer onto a storage device, such as a hard drive that is part of the persistent storage. In a tangible form, computer-readable media also may take the form of a persistent storage, such as a hard drive, a thumb drive, or a flash memory that is connected to server 110. The tangible form of computer-readable media is also referred to as computer recordable storage media. In some instances, computer-readable media may not be removable or the computer-readable media may take the form of non-tangible media, such as communications links or wireless transmissions containing the program code.

In some illustrative embodiments, program code may be downloaded over a network (e.g., network 120) to memory 130 from another computing device or computer system for use within server 110. For instance, program code stored in a computer-readable storage medium in an additional server (not shown) may be downloaded over network 120 from the additional server to server 110. The additional server providing program code in this example may be a server computer, a workstation, a client computer, or some other device capable of storing and transmitting program code.

Further, program code may be organized into computer-executable components that are functionally related. For example, program code may include one or more part agents, ordering manager agents, supplier agents, and/or any component suitable for practicing the methods described herein. Each component may include computer-executable instructions that, when executed by processor 125, cause processor unit 125 to perform one or more of the operations described herein.

The different components illustrated herein for server 110 are not meant to provide architectural limitations to the manner in which different embodiments may be implemented. The different illustrative embodiments may be implemented in a computer system including components in addition to or in place of those illustrated for server 110.

In the exemplary embodiment, an end user may connect to, and interact with, server 110 using a computing device 150 that is capable of communicating with server 110 via network 120, which may be the Internet, a LAN, a WAN, or any combination thereof. Computing device 150 may be a desktop computer, laptop, mobile device, electronic tablet, thin client, or other similar device. Computing device 150 is capable of displaying applications running inside server 110 to the end user using a computer display (not shown) or similar device. Computing device 150 is also capable of receiving user input from the end user and transmitting the received user input to server 110.

In the exemplary embodiment, server 110 is also in communication with computing device 150 and a client, such as a web client 160, via network 120. Web client 160, in the exemplary embodiment, is a web browser that is configured to run on computing device 150 and connects to server 110 as necessary to, for example, receive real-time shipping rates. In the exemplary embodiment, server 110 is also coupled to a shipping rates management database 170 via network 120.

Shipping rates management database 170 stores current shipping rate information for a plurality of freight forwarders. For example, shipping rates database 170 stores origin and destination locations for each of the plurality of freight forwarders, agreement information between carriers (e.g., ocean, land, and air carriers) and each of the plurality of freight forwarders, and up-to-date surcharges for each carrier (where applicable), and up-to-date base rates for each carrier. That is, shipping rates management database 170 stores the information needed to provide a shipper (e.g., a user) with a real time shipping quote from a point of origin in a first country to a destination point in a second country from a plurality of freight forwarders. However, while current shipping rate information is described as being stored in shipping rates management database 170, current shipping rate information may be stored in a cloud service accessible by server 110.

Embodiments of the present disclosure enable shipping rates management database 170 to compile all applicable rates for ocean, land, and air into one platform and maintain an update of these rates at all time. Therefore, shipping rates provided to a user are accurate, reliable, and obtained instantly upon request.

FIG. 2 shows a swimlane diagram 200 of an exemplary method for providing a user with international shipping rates in real time from server 110 to web client 160 located within computing device 150 (shown in FIG. 1). This method may be embodied within a plurality of computer-executable instructions stored in one or more memories, such as one or more computer-readable storage mediums. As explained above, computer storage mediums may include non-transitory and include volatile and nonvolatile, removable and non-removable mediums implemented in any method or technology for storage of information such as computer-readable instructions, data structures, program modules or other data. The instructions may be executed by one or more processors to perform the functions described herein.

At 202, web client 160 transmits a request to server 110 for shipping rates for shipping a freight from an origin location (e.g., a shipper's location) in an origin country to a destination location (e.g., a consignee's location) in a destination country (e.g., international shipping). In one embodiment, the request also includes a pick-up time and date a shipper (e.g., the user making the request) is requesting a carrier to pick-up the freight to be shipped. Further, the request may include a request for different rate options, such as, door pick-up at origin to door delivery at destination, door pick-up to port (e.g., foreign port, inland ramp, container freight station or airport), port to door delivery, or port to port only. In addition, the request also includes a size of the freight to be shipped. For example, prior to sending a request for a shipping rate, a user specifies whether the freight will FCL or LCL.

FCL is a standard container that can consist of 20 ft, 40 ft, 40 ft high cube, and 45 ft in length. In practice, it means that the whole container is intended for one consignee. FCL container shipment tends to have lower freight rates than an equivalent weight of cargo in bulk. FCL is intended to designate a container loaded to its allowable maximum weight or volume. On the other hand, LCL is a shipment that is not large enough to fill a standard cargo container. Thus, when a shipper does not have enough cargo to fill an ocean freight container, a user can select LCL service between major ports worldwide. As such, a user is provided with space within a container that is shared with other customers' goods to deliver economical usage-based costing.

At 204, the request for shipping rates for shipping the freight from the origin location in the origin country to the destination location in the destination country is received by server 110. Upon receiving the request, at 206, server 110 accesses current shipping rate information from shipping rates management database 170, which stores and manages current shipping rate information for a plurality of freight forwarders. At 208, server 110 sends web client 160 a shipping rate for each of the plurality of freight forwarders based on shipping the freight from the origin location to the destination location. At 210, web client 160 displays the shipping rates for each of the plurality of freight forwarders to the user. In one embodiment, a transit time associated with each shipping rate for each of the plurality of freight forwarders and a rating for each of the plurality of freight forwarder are also displayed to the user. As such, the shipping rates may be displayed to the user in descending or ascending order according to cost, transition time, or rating.

At 212, a user selects and commits to accept one of the shipping rates. At 214, a user may be provided with and select additional options associated with shipping the freight. For example, a user may select options for ancillary services related to international shipping, such as insurance, electronic export information (EEI) filing, customs brokerage services, E-power of attorney, required documentations, Shipper Letter of Instruction creation, and booking capabilities. Further, a user may select an option that provides an ability to book the shipment online via credit card, automated clearing house (ACH) debit, or even apply for credit. At 216, each of the user's selections is sent to server 110 for processing, and at 218, payment is executed via, for example, a payment option selected at step 214.

In one embodiment, the commitment between the user to purchase the selected shipping rate and the shipping service provided by the freight forwarder is based on either a negotiated rate arrangement (NRA) or a federal maritime commission (FMC) Tariff Filing. NRAs are written and binding arrangements between a shipper and a licensed NVOCC to provide specific transportation service for a stated cargo quantity, from origin to destination, on and after a stated date or within a defined time frame. If an NVOCC uses NRAs and meets the appropriate conditions, the NVOCC does not have to publish its rate in a tariff it makes available to the public. Thus, the NRA eliminates the bench marking and publicity concerns of many forwarders. Further, the time needed to publish a tariff, which can take several days, is negated. On the other hand, FMC Tariff Filings must be “filed” in an online format that is viewable, within reasonable means, by the public. The overall “sell rate” must be published in the tariff filing.

Embodiments of the present disclosure enable each freight forwarder to remain anonymous to a shipper even when the shipping rates of the freight forwarders are displayed to the user. Thus, until a user/shipper selects and commits to pay a particular shipping rate, the identity of the freight forwarders are unknown to the user.

### Exemplary Operating Environment

By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the disclosure are operational with numerous other general purpose or special purpose computing system environments or configurations. Examples of well known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein.

Aspects of the disclosure transform a general-purpose computer into a special-purpose computing device when configured to execute the instructions described herein.

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for providing a user with international shipping rates in real time, the system comprising:
a client;
a shipping rates database comprising current shipping rate information for a plurality of freight forwarders; and
a server comprising a processor programmed to:
receive, from the client, a request for shipping rates for shipping a freight from an origin location in an origin country to a destination location in a destination country;
access, from the shipping rates database, current shipping rate information for each of the plurality of freight forwarders; and
send the client a shipping rate for each of the plurality of freight forwarders based on shipping the freight from the origin location to the destination location.

2. The system of claim 1, wherein the current shipping rate information comprises:
origin and destination locations for each of the plurality of freight forwarders;
agreement information between carriers and each of the plurality of freight forwarders; and
up-to-date surcharges and base rates for each carrier.

3. The system of claim 1, wherein an identity of each of the plurality of freight forwarders is anonymous.

4. The system of claim 1, wherein the processor is further programmed to receive, from the client, a pick-up date for the freight, a selected commodity, dimensions and weight of the shipment and/or a size of container needed for the freight.

5. The system of claim 1, wherein at least one of the shipping rates sent to the client is a shipping rate based on shipping the freight from the origin location to the destination location using one or more of the following: an ocean carrier, airline, and truck.

6. The system of claim 5, wherein the processor is further programmed to receive, from the client, a selection of the at least one shipping rate, wherein the selection comprises a commitment to accept the selected shipping rate, and wherein the commitment is based on a negotiated rate arrangement or federal maritime commission tariff filing.

7. The system of claim 6, wherein the processor is further programmed to send, to the client, a transit time associated with each shipping rate for each of the plurality of freight forwarders based on shipping the freight from the origin location to the destination location, and a rating of each of the plurality of freight forwarders.

8. A method for providing a user with international shipping rates in real time, the method comprising:
receiving a request for shipping rates for shipping a freight from a origin location in a origin country to a destination location in a destination country;
accessing, from a shipping rates database comprising current shipping rate information for a plurality of freight forwarders, current shipping rate information for each of the plurality of freight forwarders; and
displaying, on a display device, a shipping rate for each of the plurality of freight forwarders based on shipping the freight from the origin location to the destination location.

9. The method of claim 8, wherein the current shipping rate information comprises:
origin and destination locations for each of the plurality of freight forwarders;
agreement information between ocean, ground, and air carriers and each of the plurality of freight forwarders; and
up-to-date surcharges and base rates for each carrier.

10. The method of claim 8, wherein an identity of each of the plurality of freight forwarders are displayed anonymously.

11. The method of claim 8, further comprising receiving one or more of the following: a pick-up date for the freight, a selected commodity, and a size of container needed for the freight.

12. The method of claim 8, wherein at least one of the displayed shipping rates is a shipping rate based on shipping the freight from the origin location to the destination location using one or more of the following: an ocean, ground, or air carrier.

13. The method of claim 12, further comprising receiving, from a user, a selection of the at least one shipping rate, wherein the selection comprises a commitment to accept the selected shipping rate, and wherein the commitment is based on a negotiated rate arrangement or a federal maritime commission tariff filing.

14. The method of claim 8, further comprising displaying, on the display device, a transit time associated with each shipping rate for each of the plurality of freight forwarders based on shipping the freight from the origin location to the destination location, and a rating of each of the plurality of freight forwarders.

15. At least one computer-readable storage medium having computer-executable instructions embodied thereon, wherein, when executed by at least one processor, the computer-executable instructions cause the at least one processor to:
receive a request for shipping rates for shipping a freight from an origin location in an origin country to a destination location in a destination country;
access, from a shipping rates database comprising current shipping rate information for a plurality of freight forwarders, current shipping rate information for each of the plurality of freight forwarders; and
display, on a display device, a shipping rate for each of the plurality of freight forwarders based on shipping the freight from the origin location to the destination location.

16. The at least one computer-readable storage medium of claim 15, wherein the current shipping rate information comprises:
origin and destination locations for each of the plurality of freight forwarders;
agreement information between carriers and each of the plurality of freight forwarders; and
up-to-date surcharges and base rates for each carrier.

17. The at least one computer-readable storage medium of claim 15, wherein an identity of each of the plurality of freight forwarders are displayed anonymously.

18. The at least one computer-readable storage medium of claim 15, wherein the computer-executable instructions further cause the at least one processor to receive one or more of the following: a pick-up date for the freight, a selected commodity, and a size of container needed for the freight.

19. The at least one computer-readable storage medium of claim 15, wherein at least one of the displayed shipping rates is a shipping rate based on shipping the freight from the origin location to the destination location using an ocean or air carrier.

20. The at least one computer-readable storage medium of claim 19, wherein the computer-executable instructions further cause the at least one processor to receive, from a user, a selection of the at least one shipping rate, wherein the selection comprises a commitment to accept the selected shipping rate, and wherein the commitment is based on a negotiated rate arrangement.
